(19) United States
(12) Patent Application Publication
(10) Pub. No.: US 2003/0201627 A1
(43) Pub. Date: Oct. 30, 2003

(54) WHEEL OF A GOLF TROLLEY

(76) Inventor: Liz Lin, San Diego, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/132,149

(22) Filed: Apr. 26, 2002

(51) Int. Cl. B62B 1/00

(52) U.S. Cl. 280/651

(57) ABSTRACT

A golf trolley has a frame provided with a bag supporting board, and a connecting member disposed behind the bag supporting board, and has a front wheel, and two rear wheels. The front wheel is connected to a wheel seat provided with an upper connecting block; the block is detachably connected to the connecting member with an engaging projection thereof being passed into an engaging hole of a rear side of the connecting member. The connecting block is further provided with connecting hooks on a lower side of a top board portion that extends beyond the front side thereof the hooks being engaged with connecting holes on the front side of the connecting member. The front wheel is detached from the frame together with the connecting block for reducing the size of the frame when the frame is folded for storage of the trolley.

### BACKROUND OF THE INVENTION

The present invention relates to a wheel of a golf trolley, more particular a wheel that can be easily fitted to, and detached from, the main frame of the trolley.

Golf trolleys are very popular with golf players because they help the golf players move the various golf clubs around the course that are usually very heavy in weight, dispensing with hiring a caddie to help carry the golf bags.

Golf trolleys are usually provided with two or three wheels. Three-wheeled golf trolleys include a front wheel, and two rear wheels wherein the front wheel is usually provided as a movable part so that the golf trolley can be collapsed into a smaller size for easier storage by means of moving the front wheel towards the rear wheels.

However, the above mentioned three-wheeled trolley still can't be collapsed into an ideally small size because the front wheel is still connected to the frame of the trolley, and projects beyond the other part of the collapsed trolley that is quite compact.

### SUMMARY OF THE INVENTION

Therefore, it is a main object of the present invention to provide a front wheel to a golf trolley that can be easily detached from the frame for allowing the trolley to be folded into an ideally small size.

The trolley has a frame provided with a bag supporting board, and a connecting member disposed behind the bag supporting board. And, the wheel is connected to a wheel seat provided with an upper connecting block detachably connected to the connecting member with an engaging projection of the block being passed into an engaging hole of a rear side of the connecting member; the connecting block is further provided with connecting hooks on a lower side of a top board portion that extends beyond the front side thereof, the hooks being engaged with connecting holes on the front side of the connecting member.

### BRIEF DESCRIPTION OF THE DRAWINGS

The present invention will be better understood by reference to the accompanying drawings, wherein:

FIG. 1 is a fragmentary exploded perspective view of the golf trolley according to the present invention.

FIG. 2 is a fragmentary cross-sectional view of the golf trolley of the present invention.

FIG. 3 is a fragmentary cross-sectional view of the golf trolley of the present invention with the wheel being connected to the frame.

FIG. 4 is side view of the golf trolley of the present invention.

### DETAILED DESCRIPTION OF THE PREFERRED EMBODIMENTS

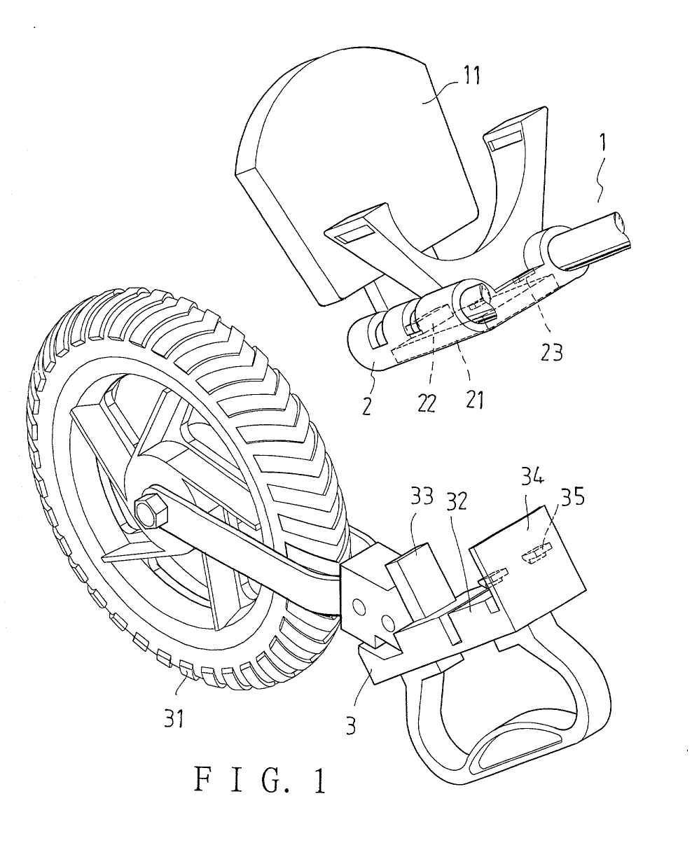

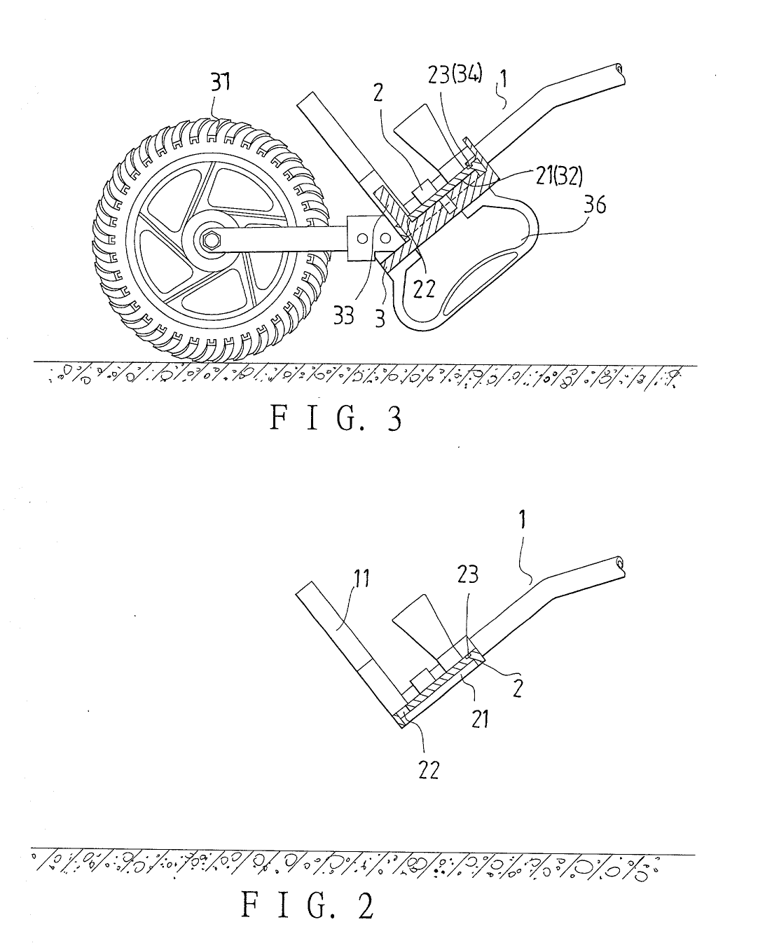

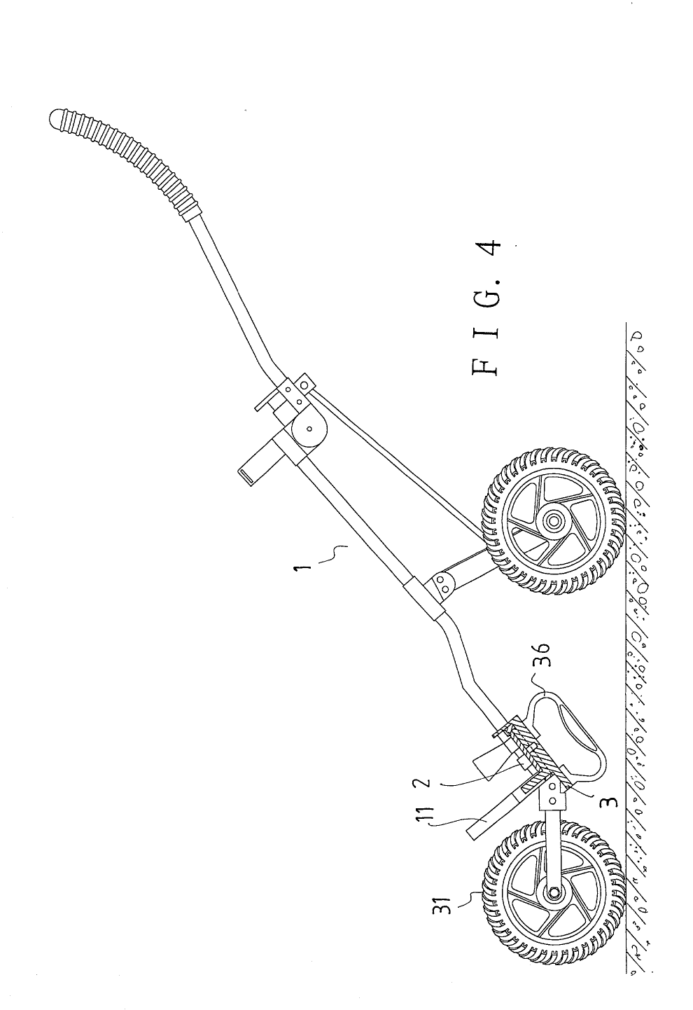

Referring to FIG. 1, a front wheel 31 of a golf trolley of the present invention is connected to a wheel seat, which is provided with a connecting block 3 at the upper end. The connecting block 3 has a front side 32, an engaging protrusion 33 sticking out from the front side 32, and a top board portion 34 extending beyond the front side of the connecting block 3. Several connecting hooks 35 are provided on the lower side of the top board portion 34.

The trolley has a frame 1, which is provided with a golf bag supporting board 11, and a connecting member 2 disposed behind the bag supporting board 11. The connecting member 2 has a recess 21 on a rear side, an engaging hole 22 on the recess 21, and several connecting holes 23 on an upper portion of a front side thereof.

To install the front wheel 31 on the frame 1 of the golf trolley, referring to FIG. 3, the connecting block 3 is joined to the connecting member 2 with the connecting hooks 35 being engaged with the connecting holes 23, the front side 32 being fitted onto the recess 21, and the engaging protrusion 33 being passed into the engaging hole 22 of the connecting member 2. To detach the block 3 from the connecting member 2, the top board portion 34 is first pushed upwards to disengage the hooks 35 from the connecting holes 23.

In addition, the connecting block 3 is provided with a handle 36 on a rear side thereof so that a user can easily hold the connecting block 3 in installing and detaching the wheel 31.

From the above description, it can be easily understood that the golf trolley wheel of the present invention has advantages as followings:

1. The golf trolley can be folded into a compact size when it is detached from the frame of the trolley.

2. The connecting block for the wheel can be easily joined to, and detached from, the connecting member of the frame.

What is claimed is:

1. A wheel of a golf trolley,
the trolley having a frame provided with a bag supporting board, and a connecting member disposed behind the bag supporting board;
the wheel being connected to a wheel seat provided with an upper connecting block detachably connected to the connecting member with a front engaging projection of the connecting block being passed into a rear engaging hole of the connecting member; the connecting block being provided with connecting hooks engaged with connecting holes of the connecting member; the connecting block being mounted onto a rear recess of the connecting member from a front side thereof.

2. The wheel of claim 1, wherein the connecting block is provided with a handle on a rear side thereof.

3. The wheel of claim 1, wherein the connecting hooks stick down from a top board portion extending beyond the front side of the connecting block, and the connecting holes are provided on a front side of an upper portion of the connecting member.
